(19) United States
(12) Patent Application Publication
(10) Pub. No.: US 2022/0366417 A1
(43) Pub. Date: Nov. 17, 2022

(54) METHOD AND APPARATUS FOR PROVIDING NON-FACE-TO-FACE USED GOODS TRANSACTION SERVICE

(71) Applicant: ACL Co.,Ltd., Incheon (KR)

(72) Inventor: Hwang Geun BAE, Incheon (KR)

(73) Assignee: ACL Co.,Ltd., Incheon (KR)

(21) Appl. No.: 17/704,017

(22) Filed: Mar. 25, 2022

(30) Foreign Application Priority Data
May 17, 2021 (KR) 10-2021-0063710

(51) Int. Cl. G06Q 20/40; G06Q 30/02; G06Q 20/42; G06Q 20/38

(52) U.S. Cl. CPC G06Q 20/4014; G06Q 30/0283; G06Q 20/42; G06Q 20/3829; G06Q 20/3825; G06Q 2220/00

(57) ABSTRACT

A method for providing a non-face-to-face used goods transaction service, includes: receiving information on a used article wanted to sell from a user terminal; inquiring a market price for the used article based on the received information; receiving user information corresponding to an item required for a sale contract of the used article from the user terminal; generating sales contract information on the user corresponding to the user information and the used article, based on the user information; receiving approval information about the sales contract information from a non-face-to-face goods storage company of the used article; providing the approval information to the user terminal; and receiving confirmation information, from at least one of the user terminal and the non-face-to-face used goods storage company, indicating that a sales price has been paid to the user.

### CROSS-REFERENCE TO RELATED APPLICATION

This application claims priority under 35 USC § 119 to Korean Patent Application No. 10-2021-0063710 filed on May 17, 2021 in the Korean Intellectual Property Office (KIPO), the entire disclosure of which is incorporated herein by reference.

### BACKGROUND OF THE INVENTION

### 1. Field of the Invention

The present invention relates to a method and an apparatus for providing a non-face-to-face used goods transaction service.

### 2. Description of the Related Art

The content described below merely provides background information related to the embodiment according to the present invention and does not constitute the prior art.

As the online second-hand market grows in size, transactions based on C2C, as well as B2C having been the basis of e-commerce, are rapidly growing. The second-hand market has been gradually globalized and enlarged with the development of information technology, and accordingly expected to have an important socio-economic impact. However, due to the incomplete system of the recent second-hand transaction, complex problems including fraud cases are continuously occurring. The safe transaction system applied in the second-hand transaction platform can solve the Internet fraud problem to some extent, however, the actual utilization rate is significantly low due to the high commission rate. Accordingly, the second-hand transaction platform actually remains at the level of providing an online space in which consumers and sellers can check information with each other. Transactions are carried out depending on mutual trust in the counter party, but the mutual trust is not easily achieved. Thus, in many cases, transacting parties only make limited transactions or use transaction schemes that incur high transaction costs.

### SUMMARY OF THE INVENTION

An object of the present invention is to provide a non-face-to-face used goods transaction service.

In addition, an object of the present invention is to provide a used goods transaction service subject to security for user information.

In order to achieve the above objects, a method for providing a non-face-to-face used goods transaction service according to one embodiment of the present invention includes the steps of: receiving information on a used article that a user wants to sell from a user terminal; inquiring a market price for the used article based on the received information; receiving user information corresponding to an item required for a sale contract of the used article from the user terminal; generating sales contract information on the user corresponding to the user information and the used article based on the user information and the market price; receiving approval information about the sales contract information from a non-face-to-face goods storage company of the used article; providing the approval information to the user terminal; and receiving confirmation information indicating that a price corresponding to the used article has been paid to the user, from at least one of the user terminal and the non-face-to-face used goods storage company.

In addition, the non-face-to-face used goods transaction service providing device according to one embodiment of the present invention may include a memory in which at least one program is recorded and a processor executing the program, in which the program may include instructions for executing: receiving information on a used article that a user wants to sell from a user terminal; inquiring a market price for the used article based on the received information; receiving user information corresponding to an item required for a sale contract of the used article from the user terminal; generating sales contract information on the user corresponding to the user information and the used article based on the user information and the market price; receiving approval information about the sales contract information from a non-face-to-face goods storage company of the used article; providing the approval information to the user terminal; and receiving confirmation information indicating that a price corresponding to the used article has been paid to the user, from at least one of the user terminal and the non-face-to-face used goods storage company.

The present invention can provide the non-face-to-face used goods transaction service.

In addition, The present invention can provide the used goods transaction service subject to security for user information.

### BRIEF DESCRIPTION OF THE DRAWINGS

FIG. 1 is a block diagram showing parties for providing a non-face-to-face used goods transaction service according to one embodiment of the present invention.

FIG. 2 is an operation flow chart showing a method for providing a non-face-to-face used goods transaction service according to one embodiment of the present invention.

FIG. 3 is an operation flow chart showing a method for providing a non-face-to-face used goods transaction service according to another embodiment of the present invention.

FIG. 4 is an operation flow chart showing a method for providing a non-face-to-face used goods transaction service according to still another embodiment of the present invention.

FIG. 5 is an operation flow chart showing a method for providing a non-face-to-face used goods transaction service according to still another embodiment of the present invention.

FIG. 6 is an operation flow chart showing a method for providing a non-face-to-face used goods transaction service according to still another embodiment of the present invention.

FIG. 7 is a view showing a computer system according to one embodiment of the present invention.

### DETAILED DESCRIPTION OF THE INVENTION

The present invention will be described in detail with reference to the accompanying drawings as follows. Herein, repeated descriptions and detailed descriptions for known functions and configurations that may unnecessarily obscure the essentials of the invention will be omitted. The embodiments of the present invention are provided in order to more completely describe the present invention to those having ordinary skill in the art. Accordingly, the shapes and sizes of elements in the drawings may be exaggerated for clearer description.

Throughout the specification, when one component “includes” some elements, it does not exclude other elements, but may further include the other elements, unless particularly stated otherwise.

Hereinafter, exemplary embodiments according to the present invention will be described in detail with reference to the accompanying drawings.

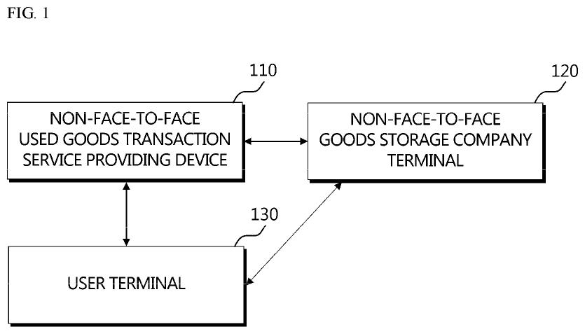

FIG. 1 is a block diagram showing parties for providing a non-face-to-face used goods transaction service according to one embodiment of the present invention.

Referring to FIG. 1, the parties for providing the non-face-to-face used goods transaction service according to one embodiment of the present invention includes a non-face-to-face used goods transaction service providing device 110, a non-face-to-face goods storage company terminal 120, and a user terminal 130.

The non-face-to-face used goods transaction service providing device 110 may refer to a device for receiving information about used goods that a user wants to sell from the user terminal 130.

The non-face-to-face used goods transaction service providing device 110 may refer to a device for receiving user information corresponding to an item required for a sales contract from the user terminal 130 to generate sales contract information.

The non-face-to-face used goods transaction service providing device 110 may perform a function of a server or platform for providing the non-face-to-face used goods transaction service.

The non-face-to-face goods storage company terminal 120 may refer to a device for providing approval information based on the sales contract information received from the user terminal 130.

The user terminal 130 may refer to a device for providing user information to the non-face-to-face used goods transaction service providing device 110.

the non-face-to-face used goods transaction service providing device 110 and the non-face-to-face goods storage company terminal 120, the non-face-to-face used goods transaction service providing device 110 and the user terminal 130, and the non-face-to-face goods storage company terminal 120 and the user terminal 130 may be connected to each other via a communication network.

The communication network refers to an access path for enabling data to be transmitted and received between the above parties. For example, the communication network may cover wired networks such as Local Area Networks (LANs), Wide Area Networks (WANs), Metropolitan Area Networks (MANs), and Integrated Service Digital Networks (ISDNs), and wireless networks such as wireless LANs, CDMA, Bluetooth, satellite communications. However, the scope of the communication network applicable to the present invention is not limited thereto.

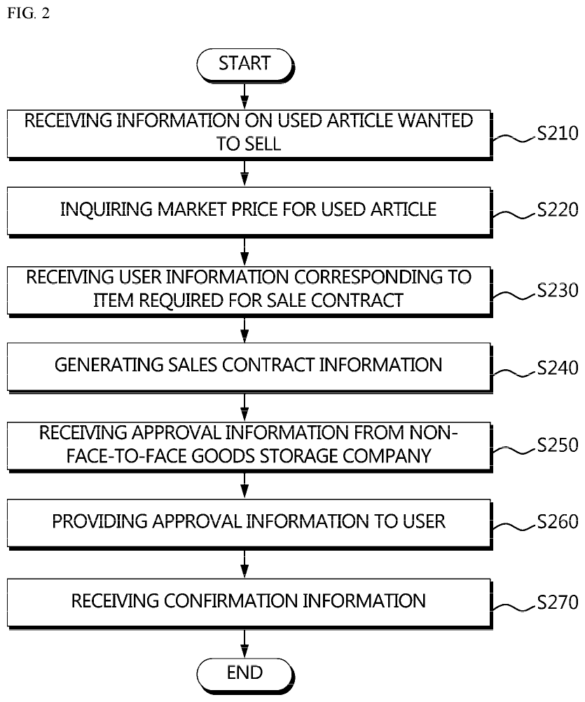

FIG. 2 is an operation flow chart showing a method for providing a non-face-to-face used goods transaction service according to one embodiment of the present invention.

Referring to FIG. 2, according to the method of providing the non-face-to-face used goods transaction service according to one embodiment of the present invention, first, the non-face-to-face used goods transaction service providing device may receive information about the used article that the user wants to sell from the user terminal (S210).

The information about the used article may include at least one of a product name, a manufacturer, a model name, an appearance status, and a function.

Next, a market price for the used article may be inquired based on the received information (S220).

Next, user information corresponding to an item required for a sale contract of the used article may be received from the user terminal (S230).

Next, sales contract information about the user and the used article corresponding to the user information may be generated based on the user information and the market price (S240).

The sales contract information may include selection information about a selling type for one of immediate selling or consignment selling.

At this point, when the immediate selling is selected as the selling type, a payment may be made while the approval information is provided to the user. When the consignment selling is selected as the selling type, the payment may be made to the user after the consigned used article is sold.

Next, approval information about the sales contract information may be received from the non-face-to-face storage company of the used article (S250).

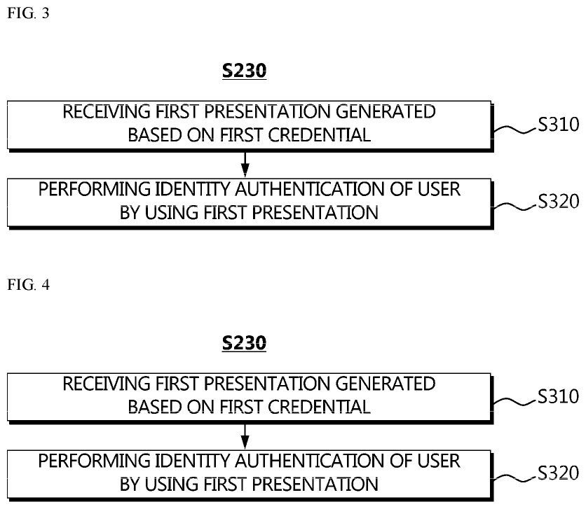

The approval information may refer to information obtained by confirming and approving the sales contract information by using a second presentation generated by the non-face-to-face storage company based on a first credential and a second credential by the user terminal. This will be described in the detailed description of FIGS. 3 and 4 described later.

Next, the approval information may be provided to the user terminal (S260).

Next, confirmation information indicating that a price corresponding to the used article has been paid to the user may be received from at least one of the user terminal and the non-face-to-face used goods storage company (S270).

FIG. 3 is an operation flow chart showing a method for providing a non-face-to-face used goods transaction service according to still another embodiment of the present invention.

Referring to FIG. 3, according to the method of providing the non-face-to-face used goods transaction service according to one embodiment of the present invention, first, the non-face-to-face used goods transaction service providing device may receive a first presentation generated based on the first credential including identity authentication information from the user terminal (S310).

The first credential may be generated from an identity authentication authority while including identity authentication information of the user and a first signature of the identity authentication authority, and may be removed from the identity authentication authority after being issued to the user terminal. In addition, the first signature may be verified using a first public key stored in an online storage.

In addition, the first presentation may include a second signature generated to be verified through the first public key by the user terminal to perform a zero-knowledge proof that the first credential includes the first signature.

The zero-knowledge proof refers to a scheme of proving that one party knows information without exposing information possessed by the one party.

Next, identity authentication on the user of the user terminal may be performed using the first presentation (S320).

Step S320 may include a step of performing identity authentication on the user of the user terminal by using the first presentation and the first public key.

Accordingly, because the non-face-to-face used goods transaction service providing device does not directly receive or store the identity authentication information about the user from the user terminal, the identity authentication information about the user can be safely protected when the server is attacked by a third party.

As a selective embodiment, when the online storage matches and stores the first public key and the second signature and the non-face-to-face used goods transaction service providing device requests a public key, it is allowed to check whether the second signature is duplicated, so that a presentation generated once may be prevented from being used multiple times.

As a selective embodiment, the user terminal may receive a selective disclosure request (SDR) from the non-face-to-face goods storage company terminal, and generate a presentation by selecting some of claims included in the second credential in response to the selective disclosure request. The non-face-to-face goods storage company terminal may indirectly check whether the user terminal includes the second credential full text by frequently changing claim items required for generating sales contract information through the selective disclosure requests.

When it is verified that at least one claim included in the presentation is included in the second credential issued by the non-face-to-face used goods transaction service providing device, and the content of the at least one claim indicates that the user terminal has generated sales contract information with the non-face-to-face used goods transaction service providing device, the non-face-to-face goods storage company terminal may transmit approval information, which is information confirmed and approved on the sales contract information, to the non-face-to-face used goods transaction service providing device.

Accordingly, when the user terminal does not have a fourth signature generated while generating the presentation together, the non-face-to-face goods storage company terminal is prohibited to provide the approval information, so that the sales contract information may be prevented from being generated by another user even when the second credential stored in the user terminal is leaked.

FIG. 4 is an operation flow chart showing a method for providing a non-face-to-face used goods transaction service according to still another embodiment of the present invention.

Referring to FIG. 4, according to the method of providing the non-face-to-face used goods transaction service according to one embodiment of the present invention, a second credential including sales contract information may be issued to the user terminal after receiving the user information and generating the sales contract information with the identity-authenticated user (S410).

More specifically, first, the user terminal may transmit user identity authentication information to the service providing device.

Next, the user terminal may receive the second credential from the service providing device.

The second credential serves as a certificate for proving that the user terminal has generated sales contract information for receiving a service, and may include a third signature used to issue the second credential with a plurality of claims.

The service providing device, in regard to the issued second credential, may store only the public key for proving the third signature and delete the rest of the information.

Accordingly, because the second credential full text issued to the user terminal is not stored in any other place including the service providing device, the user terminal may have self-sovereignty.

The user terminal may generate a fourth signature based on the third signature included in the second credential while generating a second presentation based on the first credential and the second credential, and request approval information for the sales contract information while transmitting the second presentation to the terminal of the non-face-to-face goods storage company device including the second signature.

The fourth signature may refer to a signature generated to perform the zero knowledge proof that the third signature is included in the issued second credential. In other words, the fourth signature may be exposed instead of the third signature and perform verification with the public key on the fourth signature, so as to verify that the third signature is included in the issued second credential even when the third signature is not exposed.

Accordingly, the non-face-to-face goods storage company terminal may receive the public key from an external storage in which the public key is stored and verify the second signature and the fourth signature, so as to verify whether at least one claim included in the second presentation is included in the credential issued by the service providing device, and whether the user terminal has generated the sales contract information with the service providing device with respect to the content of the at least one claim.

Accordingly, the first signature included in the first credential and the third signature included in the second credential, which are issued to the user terminal, are prevented from being exposed, so that security can be improved.

FIG. 5 is an operation flow chart showing a method for providing a non-face-to-face used goods transaction service according to still another embodiment of the present invention.

Referring to FIG. 5, according to the method of providing the non-face-to-face used goods transaction service according to one embodiment of the present invention, first, the non-face-to-face used goods transaction service providing device may issue the second credential including the sales contract information and the third signature of the service provider to the user terminal (S510).

Next, a second public key capable of verifying the third signature may be stored in the online storage (S520).

Next, temporary storage information of the issued second credential may be removed (S530).

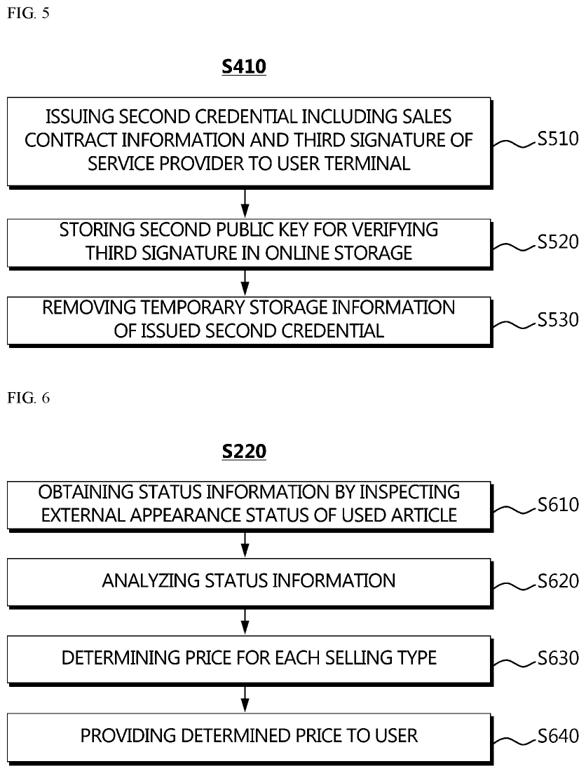

FIG. 6 is an operation flow chart showing a method for providing a non-face-to-face used goods transaction service according to still another embodiment of the present invention.

Referring to FIG. 6, according to the method of providing the non-face-to-face used goods transaction service according to one embodiment of the present invention, first, the non-face-to-face used goods transaction service providing device may inspect an external appearance status of the used article for each preset item and obtain status information (S610).

The inspection may be performed in a smart box, in which the status information about the external appearance status may be obtained by extracting device information and taking pictures using cameras.

Next, the obtained status information may be analyzed (S620).

At this point, the service providing device may analyze items including breakage, residual image level and malfunction.

For example, the used article may include a mobile device. When the used article is a mobile device, device information of the mobile device may be extracted by connecting the mobile device to a charging terminal inside the smart box. In addition, each compartment inside the smart box is equipped with a small camera for photographing the mobile device, and artificial intelligence (AI) may analyze the photos taken with the cameras and suggest a price. At this point, the preset items may include at least one of a front windshield status, a rear windshield status, a rim status, a function status and a display status of the mobile device.

Next, based on the results for the above analysis the price may be determined according to each selling type (S630).

Next, the determined price may be provided to the user (S640).

The selling type may include immediate selling and consignment selling. The user may select consignment selling only when the analysis is resulted in grade A. When the result on the analysis is not Grade A, only the price for immediate sale may be provided to the user.

In addition, the user may select the immediate selling type only when the used article is a mobile device.

For example, when the used article that the user wants to sell is a mobile device, and the result on the analysis is Grade A, the price for immediate sale provided to the user may be 180,000 Korean Won (KRW), and the price for consignment sale may be provided as 250,000 KRW. When the consignment selling is selected, a 15% consignment fee may occur.

For another example, the used article that the user wants to sell is a mobile device, and when the result on the analysis is Grade B, the price for immediate sale may be provided to the user at 80,000 KRW. At this point, because the result on the analysis is grade B, a notification saying “This product cannot be sold on this used goods platform”.

The above prices, fee rates and notification are merely examples according to the embodiment and do not limit the scope of the present invention.

As a selective embodiment, when the above selling type is the consignment selling after providing the approval information to the user terminal (S260), sales information for the used article may be uploaded to the used goods platform by using an automatic registration box.

The automatic registration box may include a darkroom for taking pictures, lightings and six small cameras. The used article may be photographed using the small cameras, and the information, prices, and photos of the used article may be uploaded to the used goods platform.

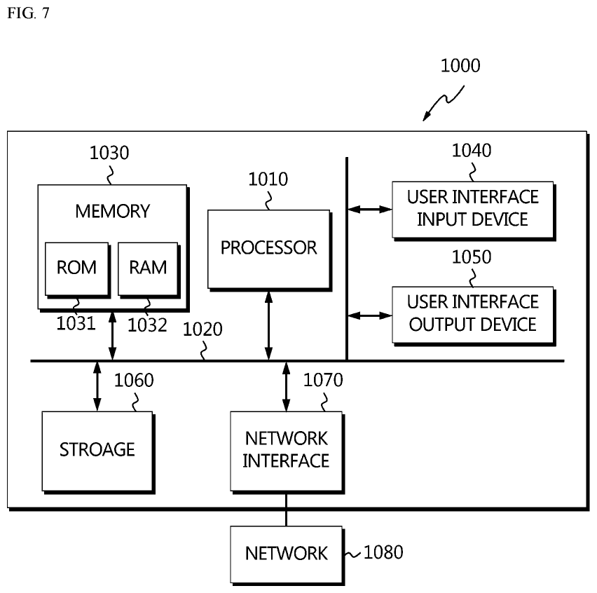

FIG. 7 is a view showing a computer system according to one embodiment of the present invention.

The non-face-to-face used goods transaction service providing device according to one embodiment of the present invention may be implemented in a computer system 1000 such as a computer-readable recording medium.

Referring to FIG. 7, the computer system 1000 may include at least one processor 1010, memory 1030, user interface input device 1040, user interface output device 1050, and storage 1060 that communicate with each other via a bus 1020. In addition, the computer system 1000 may further include a network interface 1070 connected to network 1080. The processor 1010 may be a central processing unit or a semiconductor device that executes processing instructions stored in the memory 1030 or the storage 1060. The memory 1030 and the storage 1060 may include various forms of volatile or non-volatile storage media. For example, the memory may include ROM 1031 or RAM 1032.

The specific implementations described in the present invention merely are embodiments and are not intended to limit the scope of the present invention in any case. For clarity of the specification, the description of conventional electronic components, control systems, software, and other functional aspects of the above systems may be omitted. In addition, the connections or connecting members of lines between the components shown in the drawings exemplify functional connections and/or physical or circuit-wise connections, and alternative or additional various functional connections, physical connections, or circuit-wise connections may be embodied in actual devices. In addition, unless specifically stated as “essential”, “important”, or the like, the corresponding component may not be required for application of the present invention.

Accordingly, the spirit of the present invention will not be limited to the embodiments described above, and the claims described below and all ranges equivalent to or modified from the claims will fall within the scope of the spirit of the present invention.

What is claimed is:

1. A method for providing a non-face-to-face used goods transaction service, the method comprising:
receiving information on a used article that a user wants to sell from a user terminal;
inquiring a market price for the used article based on the received information;
receiving user information corresponding to an item required for a sale contract of the used article from the user terminal;
generating sales contract information on the user corresponding to the user information and the used article based on the user information and the market price;
receiving approval information about the sales contract information from a non-face-to-face goods storage company of the used article;
providing the approval information to the user terminal; and
receiving confirmation information, from at least one of the user terminal and the non-face-to-face used goods storage company, indicating that a price corresponding to the used article has been paid to the user.

2. The method of claim 1, wherein the receiving of the user information includes:
receiving a first presentation generated based on a first credential including identity authentication information from the user terminal; and
performing identity authentication of the user of the user terminal by using the first presentation, wherein
the generating of the sales contract information includes issuing a second credential including the sales contract information to the user terminal after generating the sales contract information with the identity-authenticated user, and
the approval information includes information obtained by confirming and approving the sales contract information by using a second presentation generated by the non-face-to-face storage company based on the first credential and the second credential by the user terminal.

3. The method of claim 2, wherein the first credential is generated from an identity authentication authority while including identity authentication information of the user and a first signature of the identity authentication authority, and removed from the identity authentication authority after being issued to the user terminal,
the first signature is verifiable using a first public key stored in an online storage, and
the performing of the identity authentication includes performing the identity authentication of the user of the user terminal by using the first presentation and the first public key.

4. The method of claim 3, wherein the first presentation includes a second signature generated to be verified through the first public key by the user terminal to perform a zero-knowledge proof that the first credential includes the first signature.

5. The method of claim 4, wherein the issuing of the second credential includes:
issuing the second credential including the sales contract information and a third signature of the service provider to a user terminal;
storing a second public key for verifying the third signature in the online storage; and
removing temporary storage information of the issued second credential.

6. The method of claim 1, wherein the inquiring of the market price for the used article includes:
obtaining status information by inspecting an external appearance status of the used article for each preset item;
analyzing the obtained status information;
determining a price for each selling type based on a result of the analysis; and
providing the determined price to the user.

7. The method of claim 1, wherein the sales contract information includes selection information about a selling type for one of immediate selling or consignment selling.

8. The method of claim 7, wherein the providing of the approval information to the user terminal includes paying the price while providing the approval information to the user, when the immediate selling is selected as the selling type.

9. The method of claim 7, wherein, when the consignment selling is selected as the selling type after the providing of the approval information to the user terminal, the price is paid to the user after the consigned used article is sold.

10. A device for providing a non-face-to-face used goods transaction service, the device comprising:
a memory in which at least one program is recorded; and
a processor for executing the program, wherein
the program includes instructions for executing:
receiving information on a used article that a user wants to sell from a user terminal;
inquiring a market price for the used article based on the received information;
receiving user information corresponding to an item required for a sale contract of the used article from the user terminal;
generating sales contract information on the user corresponding to the user information and the used article based on the user information and the market price;
receiving approval information about the sales contract information from a non-face-to-face goods storage company of the used article;
providing the approval information to the user terminal; and
receiving confirmation information, from at least one of the user terminal and the non-face-to-face used goods storage company, indicating that a price corresponding to the used article has been paid to the user.
